(19) United States
(12) Patent Application Publication
(10) Pub. No.: US 2002/0023267 A1
(43) Pub. Date: Feb. 21, 2002

(54) Universal digital broadcast system and methods

(76) Inventor: Khoi Nhu Hoang, Newark, CA (US)

Correspondence Address: OPPENHEIMER WOLFF & DONNELLY, P. O. BOX 10356, PALO ALTO, CA, 94303, US

(21) Appl. No.: 09/841,792

(22) Filed: Apr. 24, 2001

Related U.S. Application Data
(63) Continuation-in-part of application No. 09/584,832, filed on May 31, 2000.

(51) Int. Cl. H04N 7/173

(52) U.S. Cl. 725/87

(57) ABSTRACT

The present invention teaches methods and systems for providing full digital services such as VOD, digital broadcast, as well as a universal set-top-box (STB) capable of handling this variety of digital services. A plurality of hardware architectures and complimentary data transmission methods identifying the distinct services through an electronic program guide enable such transmission. The universal STB of the present invention is capable of distinguishing the different services based upon information received in the electronic program guide, and is designed with unique hardware architecture including a large buffer. The present invention further provides viewing options such as multiple broadcasts and virtual VCR time-shifting features including pausing, recording, and freeze framing a broadcast without suffering the volatility and poor quality of an Internet streaming broadcast. Still further, this variety of digital services is provided via a uni-directional communication link.

### RELATED APPLICATION

This application is a continuation-in-part of Khoi Hoang's patent application entitled Systems and Methods for Providing Video on Demand Services for Broadcasting Systems filed on May 31, 2000, bearing application Ser. No. 09/584,832, which is incorporated herein by reference.

### BRIEF DESCRIPTION OF THE INVENTION

The present invention relates to video-on-demand and digital broadcast technology. In particular, the present invention teaches methods and systems for providing full digital services such as VOD, digital broadcast, and time shifting from any broadcasting medium, as well as a universal set-top-box (STB) capable of handling this variety of digital services.

### BACKGROUND OF THE INVENTION

A variety of mechanisms are available for encoding and transmitting digital data. For example, the International Organization for Standardization (or the Organisation Internationale De Normalisation) (hereinafter referred to as “the ISO/IEC”) has produced a standard (MPEG-2) for the coding of moving pictures and associated audio. Due to the ubiquity of MPEG-2 and its relevance to the present invention, some preliminary discussion is useful.

The ISO/IEC MPEG-2 standard is set forth in four documents. The document ISO/IEC 13818-1 (systems) specifies the system coding of the specification. It defines a multiplexed structure for combining audio and video data and means of representing the timing information needed to replay synchronized sequences in real-time. The document ISO/IEC 13818-2 (video) specifies the coded representation of video data and the decoding process required to reconstruct pictures. The document ISO/IEC 13818-3 (audio) specifies the coded representation of audio data and the decoding process required to reconstruct the audio data. Lastly, the document ISO/IEC 13818-4 (conformance) specifies procedures for determining the characteristics of coded bitstreams and for testing compliance with the requirements set forth in the ISO/IEC documents 13818-1, 13818-2, and 13818-3. These four documents (collectively “the MPEG-2 standard”) are incorporated herein by reference.

In the context of digital broadcast systems, a bit stream, multiplexed in accordance with the MPEG-2 standard, is a “transport stream” constructed from “packetized elementary stream” (or PES) packets and packets containing other necessary information. A “packetized elementary stream” (or PES) packet is a data structure used to carry “elementary stream data.” An “elementary stream” is a generic term for one of (a) coded video, (b) coded audio, or (c) other coded bit streams carried in a sequence of PES packets with one and only stream ID. Transport streams support multiplexing of video and audio compressed streams from one program with a common time base.

PRIOR ART FIG. 1 illustrates the packetizing of compressed video data 106 of a video sequence 102 into a stream of PES packets 108, and then, into a stream of transport stream packets 112. Specifically, a video sequence 102 includes various headers 104 and associated compressed video data 106. The video sequence 102 is parsed into variable length segments, each having an associated PES packet header 110 to form a PES packet stream 108. The PES packet stream 108 is then parsed into segments, each of which is provided with a transport stream header 114 to form a transport stream 112. Each transport stream packet of the transport stream 112 is 188 bytes in length.

Transport streams permit one or more programs with one or more independent time bases to be combined into a single stream. Transport streams are useful in instances where data storage and/or transport means are noisy. The rate of transport streams, and their constituent packetized elementary streams (PESs) may be fixed or variable. This rate is defined by values and locations of program clock reference (or PCR) fields within the transport stream.

A PES packet, as defined in the MPEG-2 standard, includes a PES packet header comprising a 24 bit start code prefix field, an eight (8) bit stream identifier field, a sixteen (16) bit PES packet length field, an optional PES header, and the payload or data section 706. Each of these fields is described in the MPEG-2 standard.

The MPEG-2 standard focuses on the encoding and transport of video and audio data. In general, the MPEG-2 standard uses compression algorithms such that video and audio data may be more efficiently stored and communicated.

PRIOR ART FIG. 2 is a block schematic showing a digital broadcast system 200 including a digital broadcast server 202 and a set-top-box 204 suitable for processing digital broadcast data. FIG. 2 illustrates not only the components of the system but also the process flow of encoding, communicating (from the digital broadcast server 202 to the set-top-box 204), and decoding video and audio data in accordance with the MPEG-2 standard. As can be seen, in the typical prior art broadcast method, the MPEG-2 transport stream is used in a streaming manner.

At the digital broadcast server 202, video data is provided to a video encoder 206 which encodes the video data in accordance with the MPEG-2 standard (specified in the document ISO/IEC 13818-2). The video encoder 206 provides encoded video 208 to a packetizer 210 which packetizes the encoded video 208. The packetized encoded video 212 provided by the packetizer 210 is then provided to a transport stream multiplexer 214.

Similarly, at the digital broadcast server 202, audio data is provided to an audio encoder 214 which encodes the audio data in accordance with the MPEG-2 standard (specified in the document ISO/IEC 13818-3). The audio encoder 214 provides encoded audio 218 to a packetizer 220 which packetizes the encoded audio 218. The packetized encoded audio 222 provided by the packetizer 220 is then provided to the transport stream multiplexer 214.

The transport stream multiplexer 214 multiplexes the encoded audio and video packets and transmits the resulting multiplexed stream to a set-top-box 204 via distribution infrastructure 224. This distribution infrastructure 224 may be, for example, a telephone network and/or a cable TV (CATV) system, employing optical fiber and implementing asynchronous transfer mode (ATM) transmission protocols. At the set-top-box 204, on a remote end of the distribution infrastructure 224, a transport stream demultiplexer 230 receives the multiplexed transport stream. Based on the packet identification number of a particular packet, the transport stream demultiplexer 230 separates the encoded audio and video packets and provides the video packets to a video decoder 232 via link 238 and the audio packets to an audio decoder 236 via link 240.

The transport stream demultiplexer 230 also provides timing information to a clock control unit 236. The clock control unit 236 provides timing outputs to the both the video decoder 232 and the audio decoder 236 based on the timing information provided by the transport stream demultiplexer 230 (e.g., based on the values of PCR fields). The video decoder 232 provides video data which corresponds to the video data originally provided to the video encoder 206. Similarly, the audio decoder 236 provides audio data which corresponds to the audio data originally provided to the audio encoder 216.

In a conventional VOD architecture, a server or a network of servers communicates with clients in a standard hierarchical client-server model. For example, a client sends a request to a server for a data file (e.g., a video data file). In response to the client request, the server sends the requested data file to the client. In the standard client-server model, one or more servers can fulfill a client's request for a data file. The client may have the capability to store any received data file locally in non-volatile memory for later use. The standard client-server model requires a two-way communications infrastructure. Currently, two-way communications require building new infrastructure because existing cables can only provide oneway communications. Examples of two-way communications infrastructure are hybrid fiber optics coaxial cables (HFC) or all fiber infrastructure. Replacing existing cables is very costly and the resulting services may not be affordable to most users.

PRIOR ART FIG. 3 shows a simplified functional block diagram of a VOD system 300. At the heart of the system is the video server 310 which routes the digital movies, resident in the movie storage system 312, to the distribution infrastructure 314. This distribution infrastructure 314 may be, for example, a telephone network and/or a cable TV (CATV) system, employing optical fiber and implementing asynchronous transfer mode (ATM) transmission protocols. The distribution infrastructure 314 delivers movies to individual homes based on the routing information supplied by the video server 310.

The VOD system 300 also includes a plurality of VOD STB 304 suitable for processing VOD in the VOD system 300. Each STB 304 receives and decodes a digital movie and converts it to a signal for display on a TV set or monitor. In addition, the distribution infrastructure 314 includes a “back channel” through which a viewer orders and controls the playing of the digital movies. The back channel routes commands from the VOD STB 304 back to the video server 310 via the distribution network 314. The primary function of the video server 310 is to route compressed digital video streams from their storage location to the requesting viewers.

As the above discussion reflects, no prior approach provides both VOD and digital broadcast within a single system. Instead, the prior approaches are limited by a variety of factors. One key limiting factor is the prior art using the MPEG-2 transport stream in the streaming manner. Additionally, prior art VOD systems require bidirectional communication links in order to operate. It is desirable to provide a system that is capable of providing digital broadcast and on-demand services to a large number of clients over virtually any transmission medium without replacing existing infrastructure. What is also needed is a way to provide viewing options for viewers such as multiple broadcasts and virtual VCR time-shifting features such as pausing, recording, and freeze framing a broadcast without suffering the volatility and poor quality of an Internet streaming broadcast. It is further desirable to provide this functionality via a uni-directional communication link.

### SUMMARY OF THE INVENTION

The present invention teaches methods and systems for providing full digital services such as VOD, digital broadcast, and time shifting from any broadcasting medium, as well as a universal set-top-box (STB) capable of handling this variety of digital services.

A first embodiment of the present invention teaches a universal broadcast system providing full digital services via a unidirectional communications link over a plurality of channels. These channels are suitable for providing one of VOD or digital broadcast. Other channels may be used for other purposes, hence the present invention does not preclude additional services.

The universal broadcast system includes digital broadcast circuitry suitable for transmitting digital broadcast data over a first channel of the universal broadcast system. The digital broadcast circuitry includes multiple digital broadcast data sources providing data intended for broadcast over the first channel, a plurality of digital data encoders, a first data merger device, a first channel server and a first channel up converter. The digital data encoders are each coupled to a corresponding unique one of the data sources and are operable to encode received data into a digital program stream format. The first data merger device is coupled to the digital data encoders and is operable to merge data received in a digital program stream format into first merged digital stream data.

The first channel server is coupled to the data merger device and is operable to generate a first modulated intermediate frequency signal from the first merged digital stream data. The first up converter device is coupled to the first channel server and is operable to convert the first modulated intermediate frequency signal into a first radio frequency signal.

The universal broadcast system further includes a combiner amplifier coupled to the first channel circuitry. The combiner amplifier is operable to amplify, condition and combine received radio frequency signals such as the first radio frequency signal. The output of the combiner amplifier is suitable to deliver the many channels of the universal broadcast system across a uni-directional communications medium.

According to another embodiment of the present invention, the universal broadcast system is further adapted to provide on-demand data through a second channel. This is accomplished through a central controlling server, a central storage device storing data intended for on-demand data provision, and data-on-demand circuitry for the second channel The data-on-demand circuitry includes a second channel server having a second channel server CPU, local memory, a modulator, and a network interface. The second channel server operable to generate a second modulated intermediate frequency signal from digital data stored in the local memory.

The data-on-demand circuitry further includes a second channel up converter device coupled to the second channel server, the second up converter device operable to convert the second modulated intermediate frequency signal into a second radio frequency signal provided to the combiner amplifier.

The central controlling server may be utilized to select the second channel and calculate a delivery matrix for transmitting data files stored on the central storage device on the second channel. The second central control server is further operable to provide offline addition, deletion, and update of data file information at the second controlling server.

One aspect of the present invention teaches a computer implemented universal data broadcast method suitable for transmitting within one broadcast system digital broadcast data within one channel and data-on-demand in another channel. This method includes providing a first channel server suitable for the transmission of digital broadcast data via a first channel, providing a second channel server suitable for the transmission of data-on-demand via a second channel. Prior to data broadcast, the method further teaches preparing a first channel server for the transmission of data-on-demand information, transmitting an electronic program guide including information indicating that the first channel contains digital broadcast data, the electronic program guide further indicating that the second channel contains on-demand data, and combining and transmitting data from the first channel and the second channel.

### BRIEF DESCRIPTION OF THE DRAWINGS

PRIOR ART FIG. 1 illustrates pictorially the packetizing of compressed video data into a stream of packets and a stream of transport packets.

PRIOR ART FIG. 2 illustrates by block diagram a system according to the MPEG-2 standard.

PRIOR ART FIG. 3 illustrates a simplified functional block diagram of a VOD system.

FIG. 4 is a block diagram of a digital broadcast server in accordance with one embodiment of the present invention.

FIG. 5 is a block diagram of a VOD server in accordance with yet another embodiment of the present invention.

FIG. 6 is a block diagram of a universal digital data server in accordance with another embodiment of the present invention.

FIG. 7 is a block diagram of a channel server suitable for use in transmitting VOD data in accordance with one embodiment of the present invention.

FIG. 8 is a block diagram showing the hardware architecture of a universal STB in accordance with yet another embodiment of the present invention.

### DETAILED DESCRIPTION OF THE INVENTION

In the following detailed description of the embodiments, reference is made to the drawings that accompany and that are a part of the embodiments. The drawings show, by way of illustration, specific embodiments in which the invention may be practiced. Those embodiments are described in sufficient detail to enable those skilled in the art to practice the invention and it is to be understood that other embodiments may be utilized and that structural, logical, and electrical changes as well as other modifications may be made without departing from the spirit and scope of the present invention.

The present invention teaches methods and systems for providing full digital services such as VOD, digital broadcast, as well as a universal set-top-box (STB) capable of handling this variety of digital services. A plurality of hardware architectures and complimentary data transmission methods identifying the distinct services through an electronic program guide enable such transmission. The universal STB of the present invention is capable of distinguishing the different services based upon information received in the electronic program guide, and is designed with a unique hardware architecture including a large buffer. The present invention further provides viewing options such as multiple broadcasts and virtual VCR time-shifting features including pausing, recording, and freeze framing a broadcast without suffering the volatility and poor quality of an Internet streaming broadcast. Still further, this variety of digital services is provided via a unidirectional communication link.

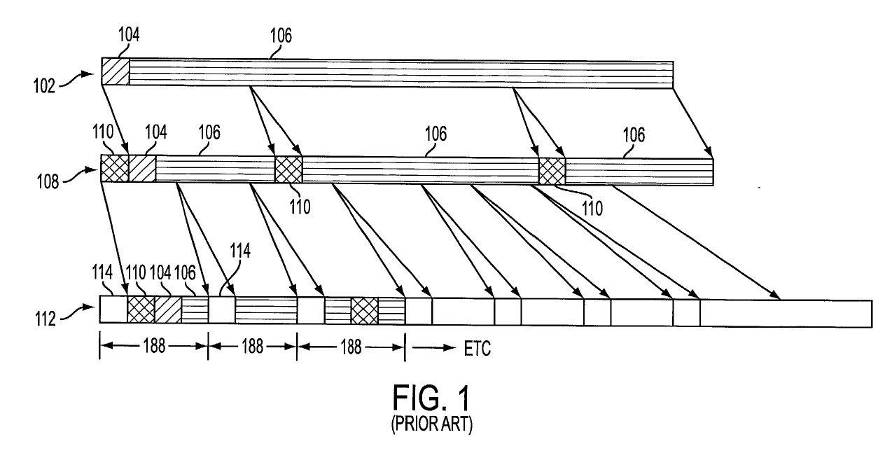

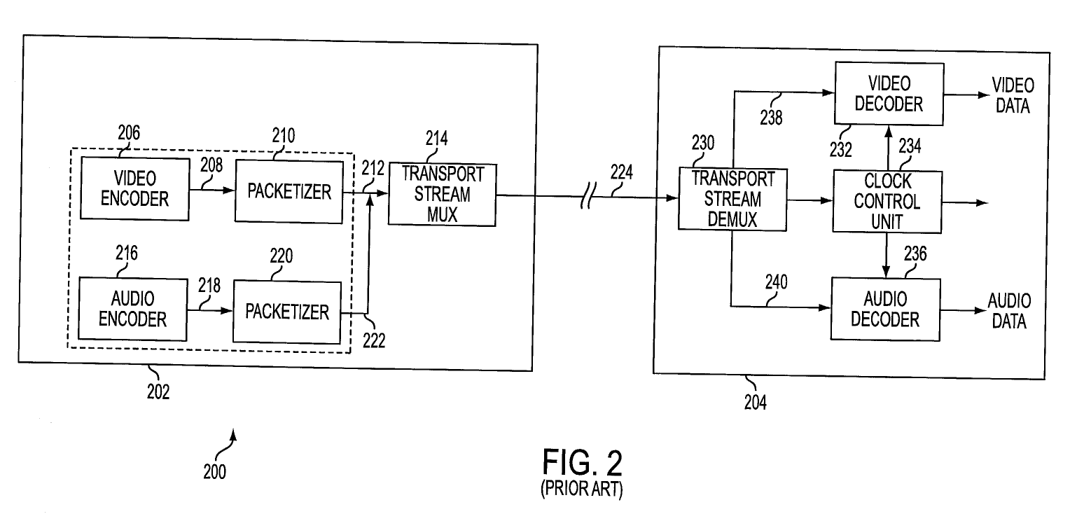

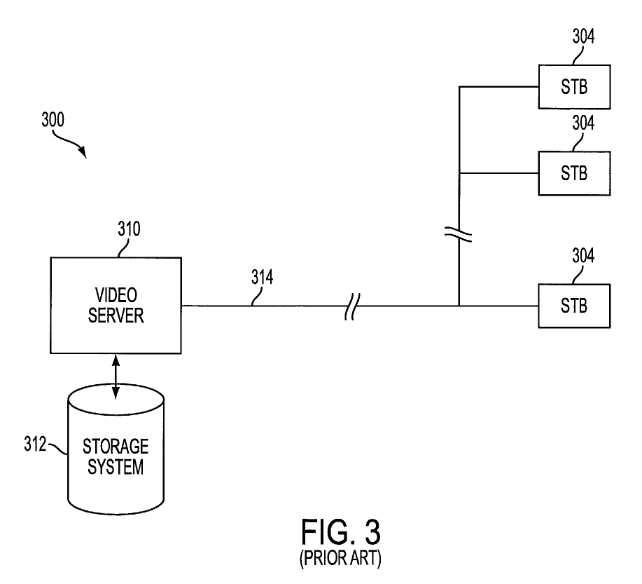

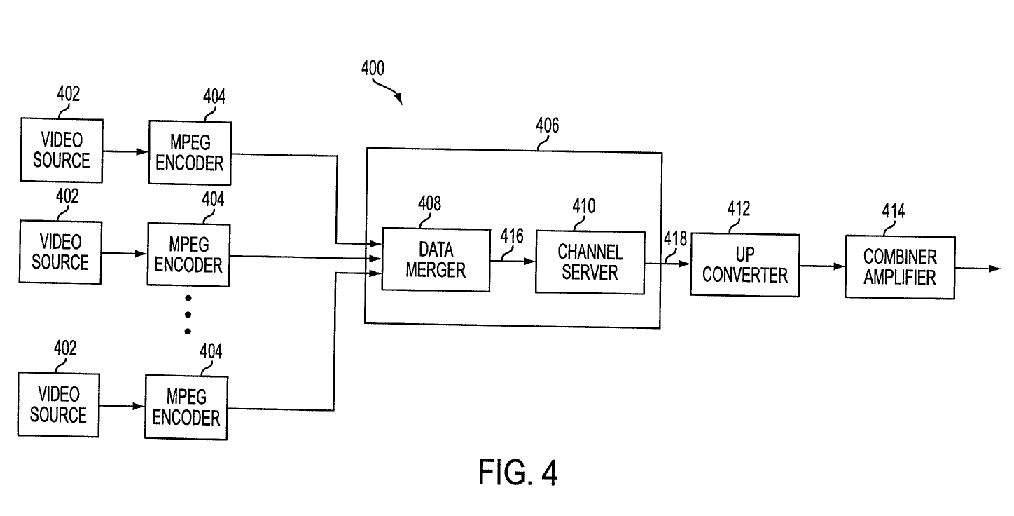

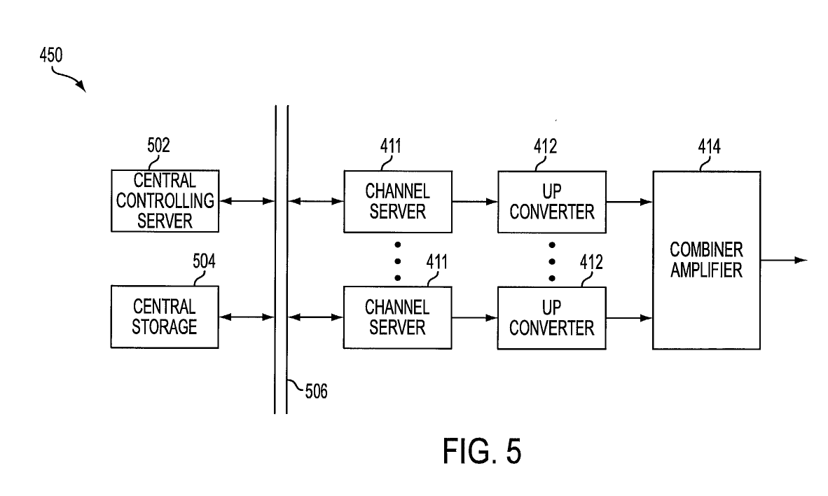

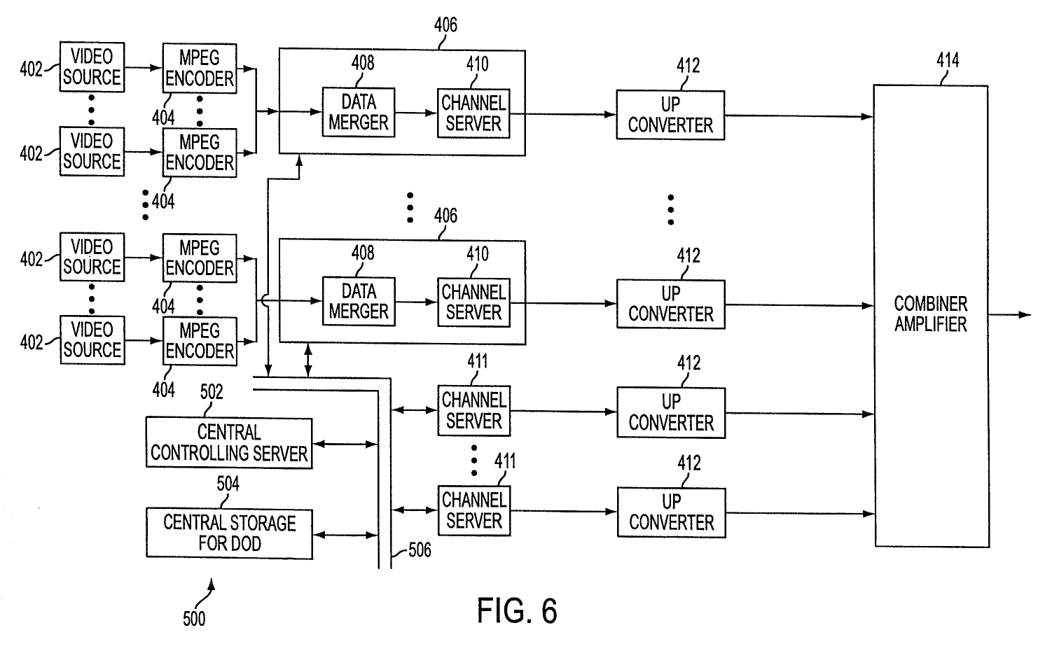

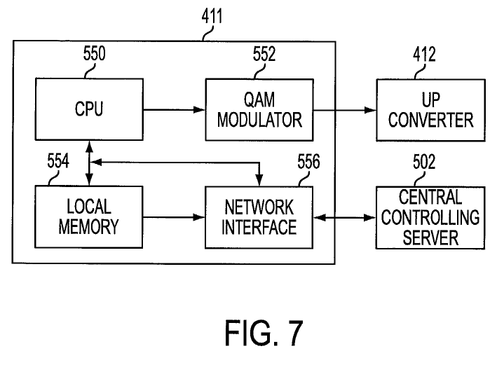

Discussion of the broadcast server will begin with FIG. 4 illustrating a digital broadcast server suitable for providing digital broadcast programming in accordance with the present invention. Turning next to FIG. 5, a VOD server in accordance with another embodiment of the present invention will be described. In FIG. 6, a universal broadcast server providing for multiple channels of digital broadcast and VOD will be described. Then with reference to FIG. 7, a channel server suitable for VOD transmission will be described.

Turning directly to FIG. 4, a single channel portion of a digital broadcast server 400 includes a plurality of video sources 402, a plurality of digital data encoders 404, a data merger device 408, a channel server 410, an up converter 412 and a combiner amplifier 414. The video sources 402 may provide analog video data (e.g., from a camera, VCR, TV program) or digital video data (e.g., MPEG file, MPEG transport stream). The digital data encoders 404 are each typically an MPEG encoder/converter hardware device, although other encoding standards are available, and the encoding may be accomplished in software.

The MPEG program stream output of the digital data encoders 404 is provided to the data merger device 408 for generation of a combined data stream 416. The data merger device 408 can take on any suitable form for the particular application. For example, the data merger device 408 may be an Ethernet switch if digital data encoders 404 output and the channel server 410 input are Ethernet compatible. The data merger device 408 may likewise be implemented within a computer system having a suitable interface.

The channel server 410 operates on the combined data stream 416 to generate an output 418 consisting of packets having sub-blocks and blocks. In a preferred embodiment, the block number will be increased sequentially and finally wrap back to zero (0) when the 32-bit, 64-bit wide or larger block number is full (i.e., 2³²−1, 2⁶⁴−1 or 2ⁿ−1). Each packet generated by the channel server 410 will include a corresponding ProgramID. This ProgramID will enable a universal STB to later determine the nature of the received data packet, e.g., digital broadcast data or on-demand data.

In preferred embodiments of the present invention, each data merger device 408 and associated channel server 410 are fabricated within a single device 406. However, these devices may be manufactured as separate devices.

FIG. 5 illustrates the architecture for a VOD server 450 in accordance with one embodiment of the present invention. The VOD server 450 includes a plurality of channel servers 411, a plurality of up converters 412 each corresponding to a channel server 411, a combiner amplifier 414, a central controlling server 502, and a central storage 504, coupled as illustrated through a data bus 506. As will be described immediately below, the central controlling server 502 controls off-line operation of the channel servers 411, as well as initiating real-time transmission once the channel servers 411 are ready. The central storage 504 stores data files in digital format.

In an exemplary embodiment, data files stored in the central storage 504 are accessible via a standard network interface (e.g., Ethernet connection) by any authorized computer, such as the central controlling server 502, connected to the network. The channel servers 411 provide data files that are retrieved from the central storage 504 in accordance with instructions from the central controlling server 502. The retrieval of digital data and the scheduling of transmission of the digital data for VOD is performed “off-line” to fully prepare each channel server 411 for real-time data transmission. Each channel server 411 informs the central controlling server 502 when ready to provide VOD, at which point the central controlling server 502 can control the channel servers 411 to begin VOD transmission.

In an preferred embodiment, the central controlling server 502 includes a graphics user interface (not shown) to enable a service provider to schedule data delivery by a drag-and-drop operation. Further, the central controlling server 502 authenticates and controls the channel servers 410 to start or stop according to delivery matrices. Systems and methods for providing unidirectional VOD broadcast matrices are taught in Khoi Hoang's patent application entitled Systems and Methods for Providing Video on Demand Services for Broadcasting Systems filed on May 31, 2000, bearing application Ser. No. 09/584,832, which is incorporated herein by reference.

The central controlling server 502 automatically selects a channel and calculates delivery matrices for transmitting data files in the selected channel. The central controlling server 502 provides offline addition, deletion, and update of data file information (e.g., duration, category, rating, and/or brief description). Further, the central controlling server 502 controls the central storage 504 by updating data files and databases stored therein.

Each channel server 411 is assigned to a channel and is coupled to an up-converter 412. The output of each channel server 411 is a quadrature amplitude modulation (QAM) modulated intermediate frequency (IF) signal having a suitable frequency for the corresponding up-converter 412. The QAM-modulated IF signals are dependent upon adopted standards. The current adopted standard in the United States is the data-over-cable-systems-interface-specification (DOCSIS) standard, which requires an approximately 43.75 MHz IF frequency. A preferred channel server 411 is described below in more detail with reference to FIG. 7.

The up-converters 412 convert IF signals received from the channel servers 104 to radio frequency signals (RF signals). The RF signals, which include frequency and bandwidth, are dependent on a desired channel and adopted standards. For example, under the current standard in the United States for a cable television channel 80, the RF signal has a frequency of approximately 559.25 MHz and a bandwidth of approximately 6MHz.

The outputs of the up-converters 412 are applied to the combiner/amplifier 414. The combiner/amplifier 414 amplifies, conditions, and combines the received RF signals then outputs the signals out to a transmission medium.

FIG. 6 illustrates a universal broadcast server 500 in accordance with an embodiment of the invention. The universal broadcast server 500 provides both on-demand and digital data broadcasting in a single broadcast server system. The universal broadcast server 500 includes a plurality of video sources 402, a plurality of digital data encoders 404, a plurality of digital broadcast devices 406 each having a data merger device 408 and a channel server 410, a plurality of channel servers 411, a plurality of up converters 412, a combiner amplifier 414, a central controlling server 502, and a central storage 504, coupled as illustrated through a data bus 506.

The central controlling server 502 controls data merger devices 408, and the channel servers 410 and 411. It will be appreciated that the digital broadcast is performed in real-time through merger of streaming program data, while the VOD service includes off-line preparation of the channel servers 411. In this way, the universal broadcast system 500 provides full digital services such as VOD and digital broadcast.

FIG. 7 illustrates an exemplary channel server 411 in accordance with an embodiment of the invention. The channel server 411 comprises a CPU 550, a QAM modulator 552, a local memory 554, and a network interface 556. The server controller 602 controls the overall operation of the channel server 411 by instructing the CPU 550 to divide data files into blocks (further into sub-blocks and data packets), in the case of data-on-demand services, selecting data blocks for transmission in accordance with a delivery matrix provided by the central controlling server 502, encode selected data, compress encoded data, then delivers compressed data to the QAM modulator 552.

The QAM modulator 552 receives data to be transmitted via a bus (i.e., PCI, CPU local bus) or Ethernet connections. In an exemplary embodiment, the QAM modulator 552 may include a downstream QAM modulator, an upstream quadrature amplitude modulation/quadrature phase shift keying (QAM/QPSK) burst demodulator with forward error correction decoder, and/or an upstream tuner. The output of the QAM modulator 552 is an IF signal that can be applied directly to an up-converter 412.

The network interface 556 connects the channel server 411 to other channel servers 411 and to the central controlling server 502 to execute the scheduling and controlling instructions from the central controlling server 502, reporting status back to the central controlling server 502, and receiving data files from the central storage 504. Any data file retrieved from the central storage 504 can be stored in the local memory 554 of the channel server 411 before the data file is processed in accordance with instructions from the server controller 502. In an exemplary embodiment, the channel server 411 may send one or more DOD data streams depending on the bandwidth of a cable channel (e.g., 6,6.5, or 8 MHz), QAM modulation (e.g., QAM 64 or QAM 256), and a compression standard/bit rate of the DOD data stream (e.g., MPEG-1 or MPEG-2).

A number of digital programs can be broadcast in an analog channel depending on the channel bandwidth, the modulation scheme and the required program bit-rate (MPEG). For example, in a 6 MHz CATV channel using QAM64, the channel maximum throughput is 27 Mb/s. If the required bit rate is 2 Mb/s, theoretically 13 digital programs can be sent over one analog channel. The actual number is smaller because of protocol overhead.

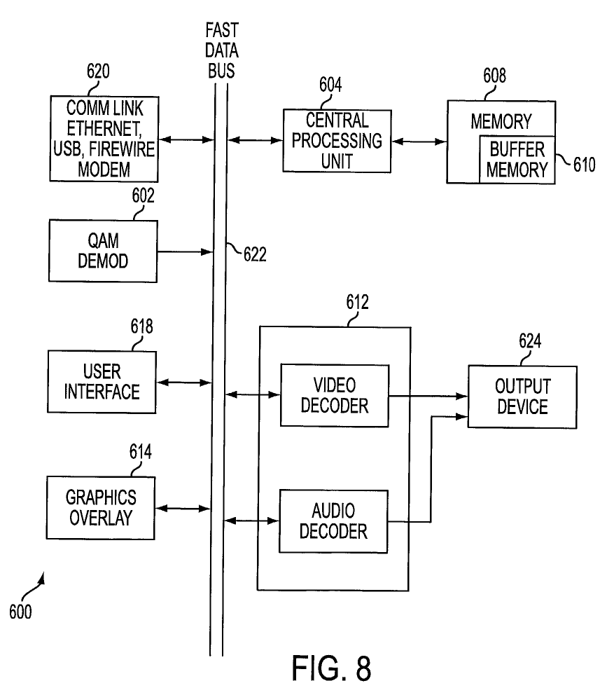

FIG. 8 illustrates a universal STB 600 in accordance with one embodiment of the invention. The STB 600 comprises a QAM demodulator 602, a CPU 604, a local memory 608, a buffer memory 610, a decoder 612 having video and audio decoding capabilities, a graphics overlay module 614, a user interface 618, a communications link 620, and a fast data bus 622 coupling these devices as illustrated. The CPU 602 controls overall operation of the universal STB 600 in order to select data in response to a client's request, decode selected data, decompress decoded data, re-assemble decoded data, store decoded data in the local memory 608 or the buffer memory 610, and deliver stored data to the decoder 612. In an exemplary embodiment, the local memory 608 comprises non-volatile memory (e.g., a hard drive) and the buffer memory 610 comprises volatile memory.

In one embodiment, the QAM demodulator 602 comprises transmitter and receiver modules and one or more of the following: privacy encryption/decryption module, forward error correction decoder/encoder, tuner control, downstream and upstream processors, CPU and memory interface circuits. The QAM demodulator 602 receives modulated IF signals, samples and demodulates the signals to restore data.

In an exemplary embodiment, when access is granted, the decoder 612 decodes at least one data block to transform the data block into images displayable on an output screen. The decoder 612 supports commands from a subscribing client, such as play, stop, pause, step, rewind, forward, etc. The decoder 612 provides decoded data to an output device 624 for use by the client. The output device 624 may be any suitable device such as a television, computer, any appropriate display monitor, a VCR, or the like.

The graphics overlay module 614 enhances displayed graphics quality by, for example, providing alpha blending or picture-in-picture capabilities. In an exemplary embodiment, the graphics overlay module 614 can be used for graphics acceleration during game playing mode, for example, when the service provider provides games-on-demand services using the system in accordance with the invention.

The user interface 618 enable user operation of the STB 600, and may be any suitable device such as a remote control device, a keyboard, a smartcard, etc. The communications link 620 provides an additional communications connection. This may be coupled to another computer, or may be used to implement bidirectional communication. The data bus 622 is preferably a commercially available “fast” data bus suitable for performing data communications in a real time manner as required by the present invention. Suitable examples are USB, firewire, etc.

In an exemplary embodiment, although data files are broadcast to all cable television subscribers, only the DOD subscriber who has a compatible STB 600 will be able to decode and enjoy data-on-demand services. In one exemplary embodiment, permission to obtain data files on demand can be obtained via a smart card system in the user interface 618. A smart card may be rechargeable at a local store or vending machine set up by a service provider. In another exemplary embodiment, a flat fee system provides a subscriber unlimited access to all available data files.

In preferred embodiments, data-on-demand interactive features permit a client to select at any time an available data file. The amount of time between when a client presses a select button and the time the selected data file begins playing is referred to as a response time. As more resources are allocated (e.g., bandwidth, server capability) to provide DOD services, the response time gets shorter. In an exemplary embodiment, a response time can be determined based on an evaluation of resource allocation and desired quality of service.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

1. A universal broadcast system providing full digital services via a unidirectional communications link over a plurality of channels, each of said channels providing one of VOD or digital broadcast, said universal broadcast system comprising:
first digital broadcast circuitry for a first channel of said universal broadcast system, said first channel being a digital broadcast channel, said first digital broadcast circuitry including:
a plurality of first digital broadcast data sources each providing data intended for broadcast in a digital broadcast mode over said first channel;
a plurality of digital data encoders each coupled to a corresponding unique one of said plurality of data sources, each of said digital data encoders operable to encode received data into a digital program stream format;
a first data merger device coupled to said plurality of digital data encoders, said data merger device operable to merge data received in a digital program stream format into first merged digital stream data;
a first channel server coupled to said data merger device, said first channel server operable to generate a first modulated intermediate frequency signal from said first merged digital stream data;
a first up converter device coupled to said first channel server, said first up converter device operable to convert said first modulated intermediate frequency signal into a first radio frequency signal; and
a combiner amplifier coupled to said first channel circuitry, said combiner amplifier operable to amplify, condition and combine received radio frequency signals such as said first radio frequency signal, said output of said combiner amplifier suitable to deliver said plurality of channels across a unidirectional communications medium.

2. A universal broadcast system as recited in claim 1, wherein at least one of said plurality of first digital broadcast sources is an analog video source.

3. A universal broadcast system as recited in claim 2, wherein said analog video source is an analog video camera.

4. A universal broadcast system as recited in claim 2, wherein said analog video source is an analog video cassette recorder.

5. A universal broadcast system as recited in claim 2, wherein said analog video source is television program source.

6. A universal broadcast system as recited in claim 1, wherein at least one of said plurality of first digital broadcast sources is an digital video source.

7. A universal broadcast system as recited in claim 6, wherein said digital video source is an MPEG data file.

8. A universal broadcast system as recited in claim 6, wherein said digital video source is an MPEG transport stream.

9. A universal broadcast system as recited in claim 1, wherein at least one of said plurality of digital data encoders is an MPEG encoder.

10. A universal broadcast system as recited in claim 1 wherein said first data merger device and said first channel server are fabricated as a single device.

11. A universal broadcast system as recited in claim 1 wherein said first digital broadcast circuitry is one of a plurality of digital broadcast circuitry for a portion of said plurality of channels of said universal broadcasts system.

12. A universal broadcast system as recited in claim 1, said universal broadcast system further comprising:
a central controlling server;
a central storage device storing data intended for on-demand data provision;
first data-on-demand circuitry for a second channel of said universal broadcast system, said second channel being a data-on-demand channel, said first data-on-demand circuitry including:
a second channel server having a second channel server CPU, local memory, a modulator, and a network interface, said second channel server operable to generate a second modulated intermediate frequency signal from digital data stored in said local memory; and
a second channel up converter device coupled to said second channel server, said second up converter device operable to convert said second modulated intermediate frequency signal into a second radio frequency signal provided to said combiner amplifier.

13. A universal broadcast system as recited in claim 12, wherein said central controlling server is operable to select said second channel and calculate a delivery matrix for transmitting data files stored on said central storage device on said second channel.

14. A universal broadcast system as recited in claim 13, wherein said central control server is further operable to provide offline addition, deletion, and update of data file information at said second controlling server.

15. A universal broadcast system as recited in claim 12 wherein said central control server manages files stored on said central storage device.

16. A universal broadcast system providing full digital services via a uni-directional communications link over a plurality of channels, each of said channels providing one of VOD or digital broadcast, said universal broadcast system comprising:
first digital broadcast circuitry for a first channel of said universal broadcast system, said first channel being a digital broadcast channel, said first digital broadcast circuitry including:
a plurality of first digital broadcast data sources each providing data intended for broadcast in a digital broadcast mode over said first channel;
a plurality of digital data encoders each coupled to a corresponding unique one of said plurality of data sources, each of said digital data encoders operable to encode received data into a digital program stream format;
a first data merger device coupled to said plurality of digital data encoders, said data merger device operable to merge data received in a digital program stream format into first merged digital stream data;
a first channel server coupled to said data merger device, said first channel server operable to generate a first modulated intermediate frequency signal from said first merged digital stream data;
a first up converter device coupled to said first channel server, said first up converter device operable to convert said first modulated intermediate frequency signal into a first radio frequency signal; and
a combiner amplifier coupled to said first channel circuitry, said combiner amplifier operable to amplify, condition and combine received radio frequency signals such as said first radio frequency signal, said output of said combiner amplifier suitable to deliver said plurality of channels across a uni-directional communications medium.
a central controlling server;
a central storage device storing data intended for on-demand data provision;
first data-on-demand circuitry for a second channel of said universal broadcast system, said second channel being a data-on-demand channel, said first data-on-demand circuitry including:
a second channel server having a second channel server CPU, local memory, a modulator, and a network interface, said first channel server operable to generate a second modulated intermediate frequency signal from digital data stored in said local memory; and
a second channel up converter device coupled to said second channel server, said second up converter device operable to convert said second modulated intermediate frequency signal into a second radio frequency signal provided to said combiner amplifier.

17. A universal broadcast system as recited in claim 16 wherein said first data merger device and said first channel server are fabricated as a single device.

18. A universal broadcast system as recited in claim 18 wherein said first digital broadcast circuitry is one of a plurality of digital broadcast circuitry for a portion of said plurality of channels of said universal broadcasts system.

19. A universal broadcast system as recited in claim 16, wherein said central controlling server is operable to select said second channel and calculate a delivery matrix for transmitting data files stored on said central storage device on said second channel.

20. A universal broadcast system as recited in claim 19, wherein said central control server is further operable to provide offline addition, deletion, and update of data file information at said second controlling server.

21. A universal broadcast system as recited in claim 16 wherein said central control server manages files stored on said central storage device.

22. A universal broadcast system providing full digital services via a uni-directional communications link over a plurality of channels, each of said channels providing one of VOD or digital broadcast, said universal broadcast system comprising:
a plurality of digital broadcast circuitry one each for a corresponding portion of said plurality of channels of said universal broadcast system each being a digital broadcast channel, each of said digital broadcast circuitry operable to generate digital broadcast data over a corresponding channel;
a central controlling server;
a central storage device storing data intended for on-demand data provision;
a plurality of data-on-demand circuitry for a corresponding portion of said plurality of channels of said universal broadcast system each being a data-on-demand channel, each of said data-on-demand circuitry operable to generate on-demand data over a corresponding channel, each data-on-demand circuitry including a corresponding channel server having a channel server CPU, local memory, a modulator, and a network interface, wherein said central controlling server is operable to select a particular data-on-demand channel and calculate a delivery matrix for transmitting data files stored on said central storage device on said data-on-demand channel, provide offline addition, deletion, and update of data file information at said second controlling server.

23. A computer implemented universal data broadcast method comprising the acts of:
providing a first channel server suitable for the transmission of digital broadcast data via a first channel;
providing a second channel server suitable for the transmission of data-on-demand via a second channel;
prior to data broadcast, preparing a first channel server for the transmission of data-on-demand information;
transmitting an electronic program guide including information indicating that said first channel contains digital broadcast data, said electronic program guide further indicating that said second channel contains on-demand data; and
combining and transmitting data from said first channel and said second channel.
